(19) United States
(12) Patent Application Publication
(10) Pub. No.: US 2005/0242597 A1
(43) Pub. Date: Nov. 3, 2005

(54) Adjustable mulching tool

(76) Inventors: David Demar, Tenafly, NJ (US); Thomas VanDyk, Ramsey, NJ (US); Roland Charriez, Mohegan Lake, NY (US); Michael Ballone, New Providence, NJ (US); John Kiely, Morris Plains, NJ (US); Keith Kristiansen, Stratford, CT (US); Melissa Fisher, Columbus, OH (US); Brian J. Conaway, Columbus, OH (US); Mandi Reese, Westerville, OH (US); Terry M. Birchler, New Albany, OH (US); Mark C. Eyman, Columbus, OH (US)

Correspondence Address: Porter, Wright, Morris & Arthur LLP;ATTN: Intellectual Property Department, 28th Floor, 41 South High Street, Columbus, OH, 43215-6194, US

(21) Appl. No.: 11/095,776

(22) Filed: Mar. 31, 2005

Related U.S. Application Data
(60) Provisional application No. 60/567,388, filed on Apr. 30, 2004.

(51) Int. Cl. A01D 9/00

(52) U.S. Cl. 294/55.5

(57) ABSTRACT

A hand-operated tool includes a tool head having a plurality of tines, a handle extending from the tool head, and a cutting member secured to the tool head and having a point at a free end. The tool head is pivotably secured to the handle to pivot about a longitudinal axis between a fork configuration and a rake configuration and a lock releasably locks the tool head relative to the handle in each of the fork and rake configurations. The handle includes an arm, a rear grip including a loop handle located at an end of the arm opposite the tool head, and a fore grip including a knob located between the tool head and the rear grip. The rear grip and the fore grip are each secured against rotation about a longitudinal axis of the handle.

### CROSS-REFERENCE TO RELATED APPLICATIONS

This application claims priority benefit from U.S. Provisional Patent Application No. 60/567,388 filed on Apr. 30, 2004, the disclosure of which is expressly incorporated herein in its entirety by reference.

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to tools and, more particularly, to hand-operated tools for lawn and gardening tasks and the like.

### BACKGROUND OF THE INVENTION

A variety of different hand-operated tools are commonly used for lawn and gardening tasks such as, for example, rakes, spades, shovels, hoes, forks and the like. These hand tools typically have a tool head and a generally straight cylindrically-shaped handle extending rearwardly from the tool head along a central longitudinal axis. In some instances, a rear end of the handle is provided with a D-shaped grip. The tool head is typically made of a metal such as, for example steel while the handle is typically of a lighter material such as wood fiberglass, plastic, or plastic.

While these prior hand-operated tools may be adequate to perform intended lawn and gardening tasks under some conditions, they can be difficult and uncomfortable to grasp and hold, particularly with two hands, and can require the operator to have a relatively large amount of hand strength. This can particularly be a concern when the hand tools are used by women, elderly, or handicapped users. Additionally, prior art tools typically are designed for a single purpose resulting in the need for many different types of tools. There is a desire for multi-purpose tools which can reduce the total number of tools needed by a user. Furthermore, there is a never ending desire to improve certain characteristics of such hand-operated tools such as, for example, quality, reliability, versatility, weather-resistance, high strength, low weight, and low manufacturing costs. Accordingly, there is a need in the art for improved hand-operated tools.

### SUMMARY OF THE INVENTION

The present invention provides a hand-operated tool which overcomes at least some of the above-noted problems of the related art. According to the present invention, a hand-operated tool comprises, in combination, a tool head and a handle extending from the tool head. The tool head is pivotably secured to the handle to pivot between first and second configurations. A lock is operable to releasably lock the tool head relative to the handle in each of the first and second configurations.

According to another aspect of the present invention, a hand-operated tool comprises, in combination, a tool head and a handle extending from the tool head. The handle includes a handle member having a loop handle forming a rear grip. The handle member has a forward grip spaced apart from the rear grip and located forward of the rear grip and he forward grip includes a knob.

According to yet another aspect of the present invention, a hand-operated tool comprises, in combination, a tool head having a plurality of tines, a handle extending from the tool head, and a cutting member secured to the head and having a point at a free end.

From the foregoing disclosure and the following more detailed description of various preferred embodiments it will be apparent to those skilled in the art that the present invention provides a significant advance in the technology of hand-operated tools. Particularly significant in this regard is the potential the invention affords for providing a high quality, reliable, adjustable, versatile, and easy to use tool with improved operational performance. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a front elevational view of hand-operated tool according to a first preferred embodiment of the present invention wherein a swiveling tool head is in a first position to operate as a fork;

FIG. 2 is a left side elevational view of the hand-operated tool of FIG. 1;

FIG. 3 is an exploded perspective view of the hand-operated tool of FIGS. 1 and 2;

FIG. 4 is a fragmented, enlarged perspective view of a portion of FIG. 3 showing a lower end of a handle of the hand-operated tool of FIGS. 1 to 3;

FIG. 5 is a left side elevational view of a handle arm of the hand-operated tool of FIGS. 1 to 4;

FIG. 6 is a rear elevational view of the handle arm of FIG. 5;

FIG. 7 is a cross-sectional view taken along line 7-7 of FIG. 5;

FIG. 8 is a is an enlarge, exploded perspective view of a forward or lower grip of the hand-operated tool of FIGS. 1 to 4;

FIG. 9 is a right side elevational view of a grip body of the lower grip of FIG. 8;

FIG. 10 is a bottom plan view of the grip body of FIG. 9;

FIG. 11 is a rear elevational view of the grip body of FIGS. 9 and 10;

FIG. 12 is an enlarged, exploded perspective view of a swiveling tool head of the hand-operated tool of FIGS. 1 to 4;

FIG. 13 is an enlarged, left side elevational view of a tool head release button of the hand-operated tool of FIGS. 1 to 4;

FIG. 14 is a rear elevational view of the tool head release button of FIG. 13;

FIG. 15 is an enlarged perspective view of a cutting member of the swiveling tool head of FIG. 13; and

FIG. 16 is a left side elevational view of the hand-operated tool of FIGS. 1 to 4 similar to FIG. 2 but with the swiveling tool head in a second position to operate as a rake.

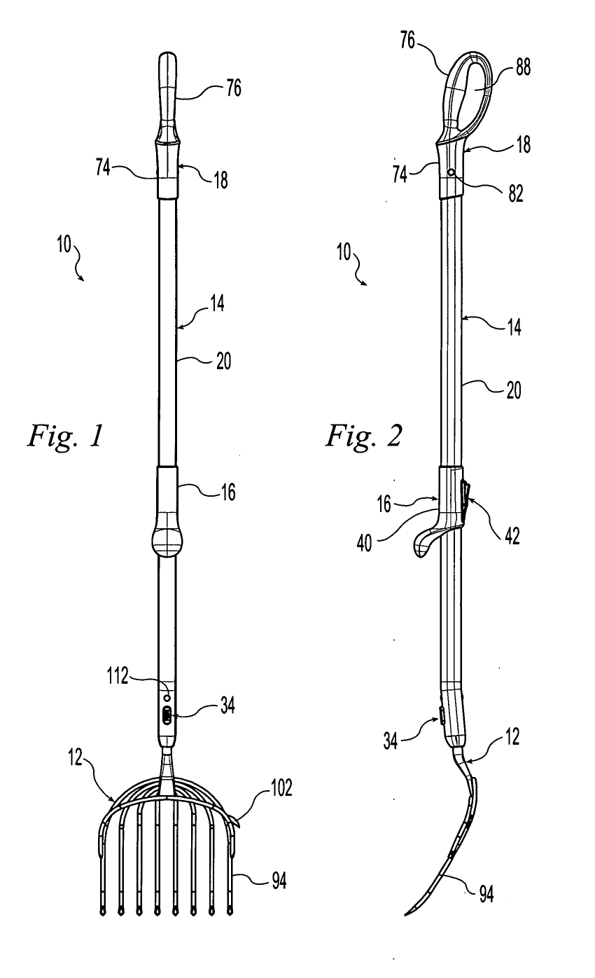

It should be understood that the appended drawings are not necessarily to scale, presenting a somewhat simplified representation of various preferred features illustrative of the basic principles of the invention. The specific design features of the hand-operated tools as disclosed herein, including, for example, specific dimensions, orientations, materials, configurations, and shapes of the various components will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the tool illustrated in the drawings. In general, up or upward refers to an upward direction within the plane of the drawing in FIG. 1 and down or downward refers to a downward direction within a plane of the paper in FIG. 1. Also in general, front refers to a direction out of the plane of the drawing in FIG. 1 and aft refers to a direction into the plane of the paper in FIG. 1. Also in general, fore or forward refers to a direction toward a tool head end of the hand-operated tools and rear or rearward refers to a direction toward an end of the hand-operated tools opposite the tool head end.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved hand-operated tools disclosed herein. The following detailed discussion of various alternative and preferred embodiments will illustrate the general principles of the invention with reference to a mulching tool for use in lawn and garden environments. Other embodiments suitable for other applications will be apparent to those skilled in the art given the benefit of this disclosure such as, for example, other hand operated-tools for lawn and garden environments and hand-operated tools used in construction, farm, and like environments.

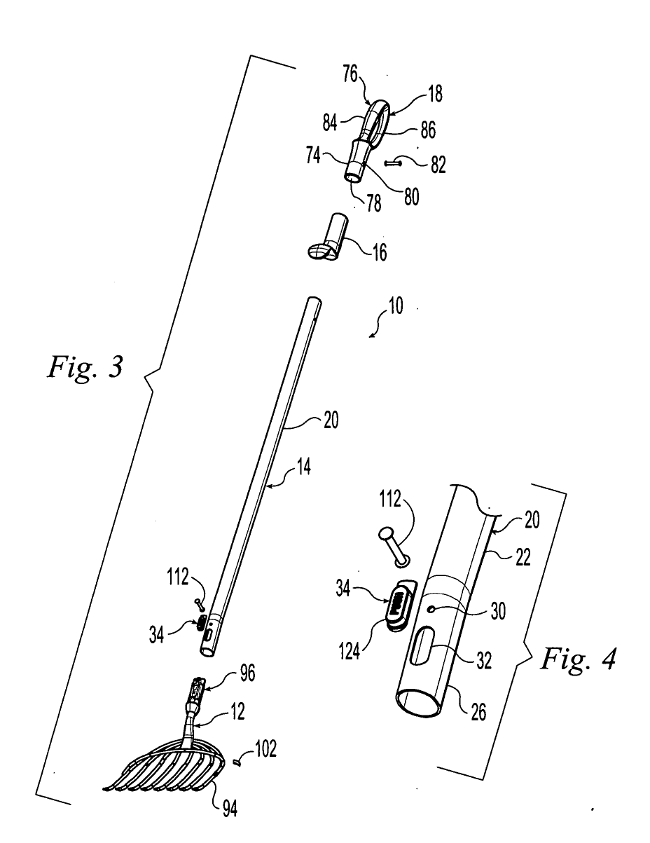

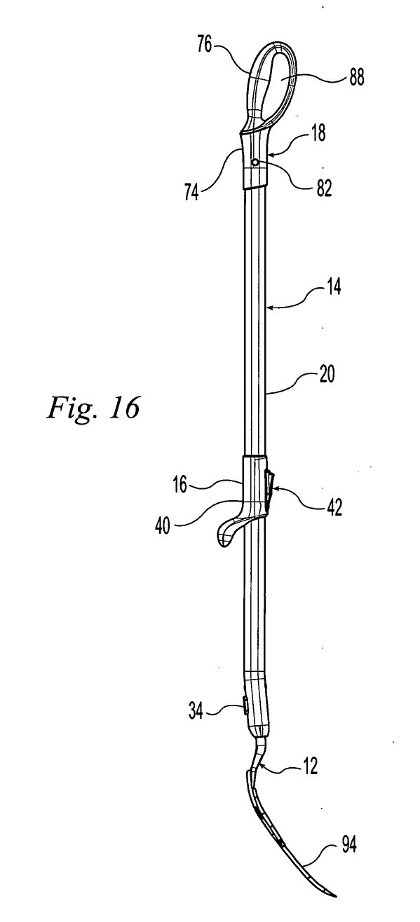

Referring now to the drawings, FIGS. 1 to 4 illustrate a hand-operated tool 10 according to a preferred embodiment of the present invention. The illustrated hand-operated tool 10 includes a tool head 12 selectively movable between a plurality of positions or orientations so that the tool 10 has a plurality of different configurations or forms, and a handle 14 rearwardly extending from the tool head 12 and including a plurality of grips 16, 18 located along the length of the handle 14. The illustrated tool 10 is in the form of a mulching tool where the tool head 12 is selectively movable between a forward facing position so that the tool 10 is in the configuration of a fork (best shown in FIG. 2) and a rearward facing position so that the tool 10 is in the configuration of a rake (best shown in FIG. 16). Preferably, at least one of the grips 16, 18 is selectively adjustable between a plurality of positions to change the longitudinal length between the grips 16, 18, and/or the longitudinal length between the grips 16, 18 and the tool head 12 and thus the effective length of the tool 10.

The illustrated handle 14 includes an arm 20, a rear grip 18 fixed in position at a rear end of the arm 20, and a fore grip 16 manually movable between desired locations along the arm 20 to selectively adjust the longitudinal length between the grips 16, 18 and thus the grasping distance of the user and the longitudinal length between the fore grip 16 and the tool head 12 and thus the effective length of the tool 10. The arm 20 preferably comprises metal such as, for example, cold rolled steel but can alternatively comprise any other suitable material. The fore and rear grips 16, 18 preferably comprise plastic material such as, for example, polypropylene The illustrated arm 20 and grips 16, 18 are each formed as separate components and operably fastened together but it is noted that any combination of the arm 20 and grips 16, 18 can alternatively be formed as a unitary, that is one-piece, member. It is also noted that while the illustrated tool 10 is provided with a fixed length handle 14, the tool 10 can alternatively be provided with an adjustable length handle.

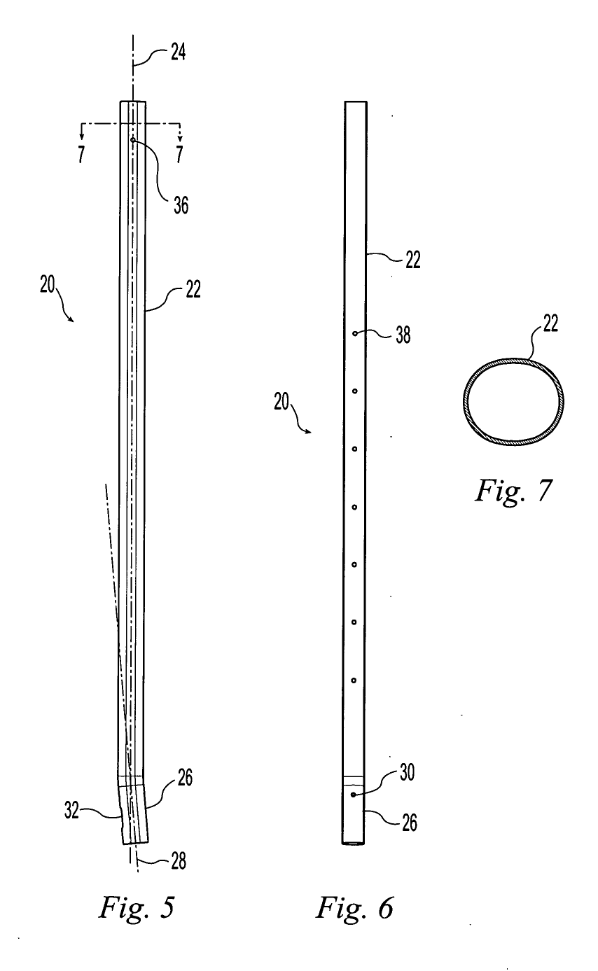

As best shown in FIGS. 5 to 7, the illustrated arm 20 is sized and shaped to cooperate with the fore and rear grips 16, 18 and the tool head 12 as described in more detail hereinafter. The illustrated arm 20 has a substantially straight upper or main portion 22 forming a central longitudinal axis 24 for the handle 14 and a substantially straight lower or head portion 26 forming a central longitudinal axis 28 of rotation for the tool head 12. The illustrated upper and lower portions 22, 26 form an acute angle therebetween so that the tool head 12 extends from the handle 14 at a desired angle. The illustrated upper and lower portions 22, 26 form an acute angle of about 6 degrees therebetween but any other suitable angle can alternatively be utilized. The illustrated lower portion 26 has a length suitable for receiving the tool head 12 therein as described in more detail hereinafter. The arm 20 preferably has a length such that the total length of the tool 10 is from about 50 to about 60 inches and more preferably has a length such that the total length of the tool is about 56 inches but any suitable length can be utilized.

The illustrated arm 20 is tubular-shaped but alternatively can be at least partially solid. The illustrated arm 20 is oval-shaped in cross-section to cooperate with the fore grip 16 to prevent rotation of the fore grip 16 relative to the arm 20 as described in more detail hereinafter but the arm 20 can alternatively have a cross-section of any other suitable shape. The illustrated arm 20 is also sized to closely receive the tool head 12 therein at its lower end but the arm 20 can alternatively be sized to closely slide into the tool head 12. The illustrated head portion 26 of the illustrated arm 20 is provided with openings 30 in a forward-rearward direction for securing the tool head 12 to the arm 20 as described in more detail. The illustrated head portion 26 is also provided with a forward facing opening 32 sized and shaped to cooperate with a tool head lock 34 as described in more detail hereinafter. Also the illustrated arm 20 is sized to closely extend into the fore and rear grips 16, 18 but can alternatively be sized to extend over portions thereof. The main portion 22 of the illustrated arm 20 is provided with openings 36 in a lateral direction for securing the rear grip 18 to the upper end of the arm 20 as described in more detail. The main portion 22 of the illustrated arm 20 is also provided with a plurality of longitudinally spaced-apart openings 38 on a rear side of the main portion 22 for selectively securing the fore grip 16 to the arm 20 in a plurality of positions as described in more detail. The illustrated arm 20 is provided with seven fore grip openings 38 but any other quantity can alternatively be utilized.

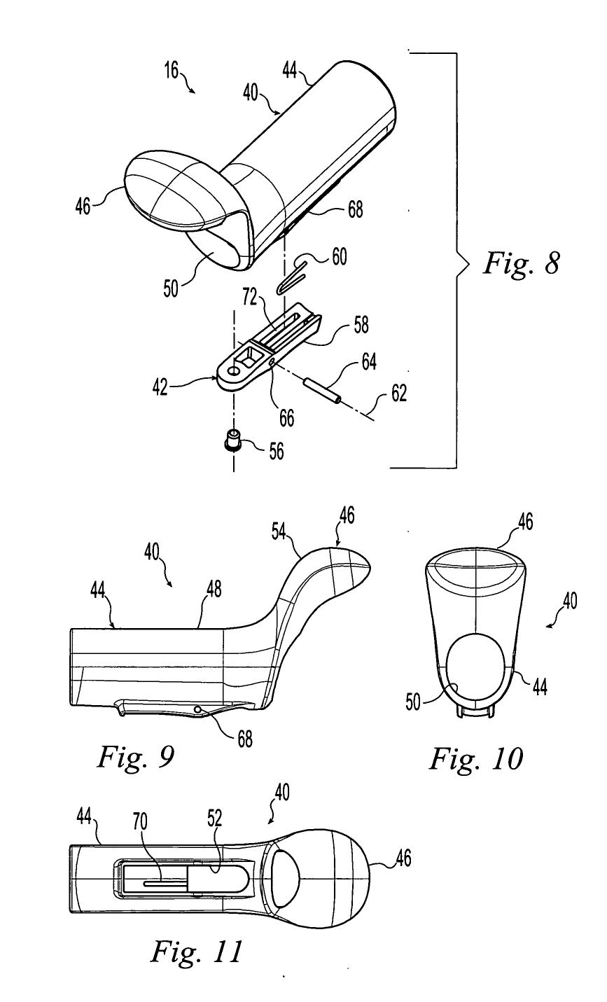

As best shown in FIGS. 8 to 11, the fore grip 16 includes a body 40 selectively movable along the arm 20 and a manually releasable lock 42 to selectively secure the body 40 in a plurality of positions along the longitudinal length of the arm 20 to adjust the distance between the rear grip 18 and the fore grip 16 and the distance between the fore grip 16 and the tool head 12. The illustrated fore grip lock 42 is adapted so that the body 40 is adjustable to a finite number of fixed positions defined by the seven openings 38 in the arm 20. It is noted, however, that the fore grip lock 42 can alternatively have any other quantity of fixed positions or can alternatively be adapted so that the body 40 is infinitely adjustable along the longitudinal length of the arm 20.

The illustrated fore grip body 40 includes a generally cylindrical-shaped main portion 44 and a knob portion 46 extending from the main portion 44. The illustrated main portion 44 is sized and shaped to form a first gripping or grasping surface 48 for the user wherein the users hand is placed over and around the outer surface of the main portion 44. The main portion 44 forms a longitudinally extending passage 50 for closely receiving the arm 20 therethrough so that the body 40 can slide long the length of the arm 20. The illustrated passage 50 is provided with an oval-shaped cross-section which cooperates with the oval-shaped cross-section of the arm 20 so that the body cannot rotate relative to the arm as it slides along the length of the arm to maintain the fore grip 16 in its desired orientation. It is noted that the passage 50 and/or the arm 20 can alternatively have cross-sections of any other non-circular or other suitable shape and/or other means for preventing rotation of the fore grip 16 can be provided. The rear side of the illustrated main portion 44 is provided with an opening 52 sized and shaped for cooperating with the fore grip lock 42 as described in more detail hereinafter. The illustrated knob portion 46 extends forwardly away from the arm 20 and downwardly toward the tool head 12 from a lower end of the main portion 44. The illustrated knob portion 46 is sized and shaped to form a second gripping or grasping surface 54 for the user wherein the users hand is placed over and around the knob portion 46. It is noted that the fore grip 16, the main portion 44, and/or the knob portion 46 can alternatively have any other suitable size and/or shape.

The illustrated fore grip lock 42 includes a lock pin 56 adapted to engage the openings 38 of the arm 20 to rigidly lock the fore grip 16 and the arm 20 together, a release arm or lever 58 adapted to manually move the lock pin 56 at least from a locking position wherein the lock pin 56 engages one of the openings 38 to a releasing position wherein the lock pin 56 is free of the openings 38, and a spring member 60 adapted to resiliently bias the lock pin 56 into the locking position. The illustrated release lever 58 is located within the rear opening 52 of the body 40 and pivotably mounted to the body 40 about a laterally extending pivot axis 62. The illustrated pivot axis 62 is formed by a laterally extending axle 64 extending through an opening 66 in the release lever 58 and openings 68 on opposed lateral sides of the rear opening 52 of the body 40. The illustrated axle 64 is a dowel pin but any other suitable type of axle can be alternatively utilized. The illustrated lock pin 56 is secured to a lower end of the release lever 58 so that it is carried by the release lever and extends radially inward toward the central longitudinal axis 24 of the arm 20. The lock pin 56 is sized and shaped to be closely received into the openings 38 in the arm 20. The illustrated spring member 60 is located at an upper end of the release lever 58 to resiliently bias the upper end of the release lever 58 in a radially outward direction and the lower end of the release lever 58 in a radially inward direction so that the lock pin 56 is biased towards its locking position. The illustrated spring member 60 is a V-shaped wire spring secured in grooves 70, 72 formed in the body 40 and the release lever 58. It is noted that any other suitable type of spring member 60 can alternatively be utilized. It is also noted that the fore grip lock 42 can alternatively take any other suitable form.

Assembled in this manner, the user can selectively release the fore grip lock 42 to adjust the position of the fore grip 16, and thus the distance between the fore grip 16 and the rear grip 18 and the distance between the fore grip 16 and the tool head 12, by depressing the upper end of the release lever 58 against the bias of the spring member 60 to outwardly pivot the lower end of the release lever 58 and move the lock pin 56 to its releasing position so that the body 40 can longitudinally slide along the arm 20 to a desired position. When the user releases the release lever 58, the spring member 60 resiliently pivots the release lever 58 to automatically move the lock pin 56 towards its locking position. If the lock pin 56 does not engage one of the openings 38, the user slides the body 40 toward a desired position until the lock pin 56 resiliently snaps into one of the openings 38 to secure the fore grip 16 to the arm 20 in the desired position. The above steps are repeated to return the fore grip 16 to its original position or to move the fore grip 16 to any other desired position.

The illustrated rear grip 18 includes a generally cylindrical-shaped body 74 and a loop handle 76 extending from the body 74. The body 74 forms a downward facing socket 78 for receiving the upper end of the arm 20. Openings 80 extending in a lateral direction are provided at the socket 78. The illustrated rear grip 18 is rigidly secured to the arm 20 by a rivet 82 extending laterally through the openings 36, 80 in the arm 20 and the body 74. It is noted that the rear grip 18 can be alternatively secured to the handle arm 20 in any other suitable manner and can be either fixed in position or adjustable. The loop handle 76 extends rearwardly from the body 74 so that a gripping or grasping portion 84 is generally an extension of the arm 20 along the longitudinal axis 24 of the arm 20. The gripping portion 84 is generally cylindrical but is ergonomically shaped for comfortable grasping by the user. A loop portion 86 extends between upper and lower ends of the gripping portion 84 at a rear side of the rear grip 18 to form a laterally extending opening 88 for passage of a portion of the users hand therethrough when grasping the rear grip 18. It is noted that the rear grip 18, the body 74 and/or the loop handle 76 can alternatively have any other suitable size and/or shape.

The illustrated tool head 12 is secured to the lower end of the handle 14 in a manner in which the tool head 12 is movable between a plurality of orientations relative to the handle 14. The illustrated tool head 12 selectively rotates or swivels about the axis 28 formed by the head portion 26 of the arm 20. The manually releasable tool head lock 34 is provided to selectively secure the tool head 12 in the desired positions. The illustrated tool head 12 can be selectively secured by the tool head lock 34 in two positions relative to the handle 14. It is noted, however, that the tool head lock 34 can alternatively secure the tool head 12 in any other quantity of fixed positions or can alternatively be adapted so that the tool head 12 can be secured in an infinite number of positions.

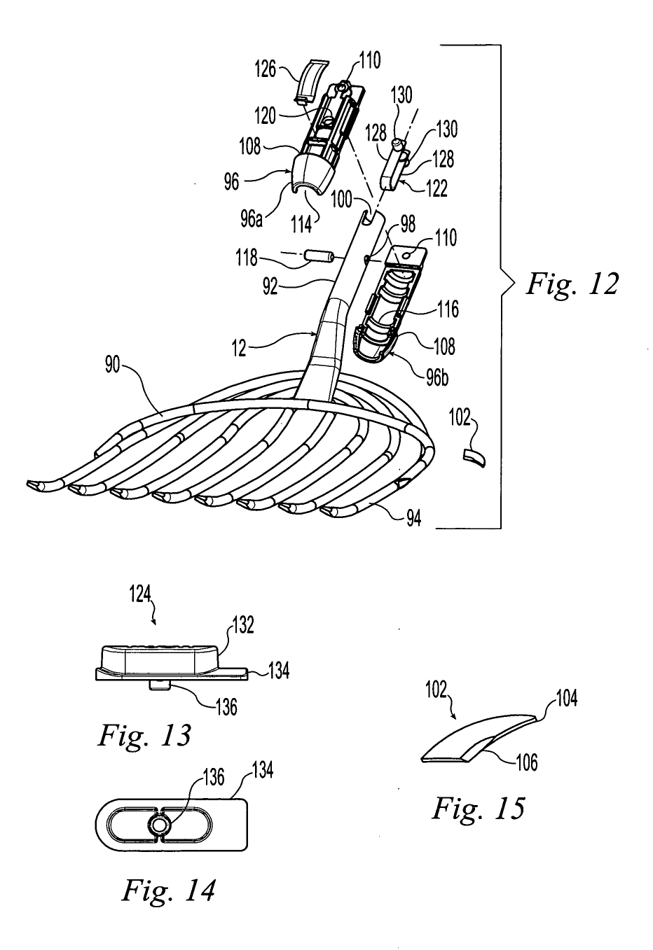

The illustrated tool head 12 is in the form of a fork (best shown in FIG. 2) or a rake (best shown in FIG. 16) depending on its orientation relative to the handle 14. As best shown in FIG. 12, the illustrated tool head 12 has a main portion 90 and a connecting portion 92. The illustrated main portion 90 includes a plurality of parallel and spaced apart tines or teeth 94. The illustrated tines 94 are formed by wires but can alternatively be formed in any other suitable manner. The free ends of the tines 94 are preferably ultra sharp and durable so that desired tasks during use of the hand tool 10 can be performed with less effort and/or hand strength of the user. The illustrated connecting portion 92 is tubular and is sized and shaped to cooperate with the tool head lock 34 and with a swivel housing 96 which secures the tool head 12 to the handle 14 in a manner which permits rotation of the tool head 12 about the axis 28 but substantially prevents axial and radial movement of the tool head 12 relative to the handle 14. The illustrated connecting portion 92 is provided with a laterally facing openings 98 sized and shaped to cooperate with the swivel housing 96 as described in more detail hereinafter. The illustrated connecting portion 92 is also provided with a pair of forward and rearward facing openings 100 in the form of notches which are sized and shaped to cooperate with the tool head lock 34 as described in more detail herein after. The tool head 12 is preferably formed of a metal such as, for example, carbon steel but can alternatively be formed of any other suitable material.

The illustrated tool head 12 also include a cutting member 102 in the form of a blade or the like. The cutting member 102 can be advantageous to open plastic bags and the like such as, for example, mulch bags. As best shown in FIG. 15, the illustrated cutting member 102 has a sharp point 104 at a free end of the cutting member 102 and a cutting edge 106 along at least one edge of the cutting member 102. Formed in this manner, the sharp point 104 can be used to pierce the bag and then the cutting edge 106 can be used to cut the bag. The illustrated cutting member 102 is secured to the side of the tool head 12 near an upper end of the outer tine 94. The cutting member 102 is preferably formed of a metal such as, for example, carbon steel but can alternatively be formed of any other suitable material and is preferably welded to the tool head 12 but can alternatively be secured in any other suitable manner.

As best shown in FIG. 12, the illustrated swivel housing 96 includes upper and lower housing members 96a, 96b which cooperate to form the generally cylindrical-shaped housing 96 sized for insertion into the lower end of the handle arm head portion 26. The upper and lower housing members 96a, 96b cooperate to form an upward facing abutment 108 which engages the end of the handle arm 20 to limit insertion of the swivel housing 96 into the handle arm 20. The illustrated upper and lower housing members 96a, 96b have openings 110 in a forward rearward direction at an upper end. The illustrated swivel housing 96 is rigidly secured to the arm 20 by a rivet 112 extending through the openings 30, 110 in the arm 20 and the swivel housing 96. It is noted that the swivel housing 96 can be alternatively secured to the handle arm 20 in any other suitable manner. The upper and lower housing members 96a, 96b cooperate to form a downward facing socket 114 sized and shaped to closely receive the connecting portion 92 of the tool head 12. Along the length of the socket 114, a radially extending groove 116 is provided which forms upward and downward facing abutments. A dowel pin 118 laterally extends through the opening 98 in the tool head connecting portion 92 and is located within the groove 116 so that the pin 118 rotates within the groove 116 to permit the tool head 12 to rotate relative to the handle arm 20 and the pin 118 engages the upward and downward facing abutments of the groove 116 to substantially prevent axial movement of the tool head 12 relative to the handle arm 20. The socket 114 is also sized and shaped to closely receive the tool head connecting portion 92 to substantially prevent radial movement of the tool head 12 relative to the handle arm 20. The illustrated socket is also provided with a forward facing opening 120 located above the groove 116. The opening 120 is sized and shaped to cooperate with the tool head lock 34 as described in more detail hereinafter.

The illustrated tool head lock 34 is provided to releasably secure the tool head 12 in both the fork configuration (best shown in FIG. 2), wherein the tines 94 extend in a forward direction from the axis 28, and the rake configuration, wherein the tines 94 extend in a rearward direction from the axis 28. The illustrated tool head lock 34 includes a lock member 122 which is resiliently biased into a locking position which prevents pivotable movement of the tool head 12 relative to the handle arm 20, a release member or button 124 which is manually actuatable to move the lock member 122 from its locking position to unlocking position which permits pivotable movement of the tool head 12 relative to the handle arm 20, and a spring member 126 which resiliently biases the release member 124 outward to a non-actuating position which prevents release of the lock member 122.

The illustrated lock member 122 is a generally U-shaped spring member having a pair of legs 128 joined at one end and a pair of opposed pins 130 outwardly extending from free ends of the legs 128. The illustrated lock member 122 resiliently biases the pins 130 in an outward direction but the pins 130 can be independently moved inwardly against the bias of the lock member 122. The lock member 122 is preferably formed of stainless steel but can alternatively be formed of any other suitable material. The illustrated lock member 122 is sized and shaped to be positioned within the tool head connector portion 92 with the pins 130 extending through the openings 100 at the upper end of the tool head connecting portion 92. When the tool head 12 is oriented with either of the pins 130 aligned with the opening 120 in the swivel housing 96, the pin 130 engages the opening 120 to lock the tool head 12 against rotation about the axis 28 relative to the swivel housing 96 and the handle arm 20. It is noted that the opposite pin 130 is inwardly moved against its outward bias because it engages an inner surface of the swivel housing socket 114 which does not permit the pin 130 to extend fully outward.

As best shown in FIGS. 13 and 14, the illustrated release member 124 includes a button portion 132, a flange 134 extending from a rear end of the button portion 132, and a protrusion 136 rearwardly extending from a rear side of the button portion 132. The illustrated button portion 132 is sized and shaped to extend through the opening 32 in the lower end of the handle arm 20. The illustrated flange 134 is sized to engage the inner surface of the handle arm 20 to limit outward movement of the release member 124 through the opening 32 and retain the release member 124 to the handle arm 20. The illustrated protrusion 136 is sized and shaped to cooperate with the swivel housing opening 120 and the lock member pin 130 so that inward movement of the release member 124 causes the protrusion 136 to inwardly deflect the lock member pin 130 out of engagement with the swivel housing opening 120. The release member 124 is preferably formed of glass filled Nylon but any other suitable material can be utilized. The illustrated spring member 126 is sized and shaped to resiliently bias the release member 124 in an outward direction so that the protrusion 136 does not inwardly deflect the lock member pin 130 out of engagement with the swivel housing opening 120. The illustrated spring member 126 is a spring clip adapted to cooperate with the outer surface of the swivel housing 96. The spring member 126 is preferably formed of spring steel but any other suitable material can alternatively be utilized. It is noted that any other suitable type of spring member 126 can alternatively be utilized. It is also noted that the tool head lock 34 can alternatively take any other suitable form.

Assembled in this manner, the user can selectively release the tool head lock 34 to adjust the orientation of the tool head 12, and thus the configuration of the tool 10 (best shown in FIGS. 2 and 16). When the user depresses the release member 124 against the outward bias of the spring member 126, the protrusion 136 resiliently depresses the lock member pin 130 out of engagement with the swivel housing opening 120. With the lock member 122 moved to its unlocking position, the user can rotate the tool head 12 about the axis 28 until the other locking member pin 130 aligns with the swivel housing opening 120 and, after the user releases the release member 124, resiliently snaps outward to engage the swivel housing opening 120 and lock the tool head 12 against further rotation. The above steps are repeated to return the tool head 12 to its original orientation.

It is apparent from the foregoing detailed description that the present invention provides improved hand-operated tool 10 which is relatively comfortable to use, requires relatively low hand strength, and is extremely versatile in that a single preferred tool can replace a number of prior art tools to accomplish the same tasks. It should be appreciated that the single tool 10 according to the illustrated embodiment can be used to open mulch bags and spread mulch rather than using a prior art fork, rake, and utility knife to do the same task. It is also apparent that the improved tool 10 is reliable and has relatively low manufacturing costs.

From the foregoing disclosure and detailed description of certain preferred embodiments, it will be apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

1. A hand-operated tool comprising, in combination:
a tool head;
a handle extending from the tool head;
wherein the tool head is pivotably secured to the handle to pivot between first and second configurations; and
a lock operable to releasably lock the tool head relative to the handle in each of the first and second configurations.

2. The hand-operated tool according to claim 1, wherein the tool head pivots about a longitudinal axis and can rotate 360 degrees.

3. The hand-operated tool according to claim 1, wherein the tool head pivots about a longitudinal axis and the tool head pivots about 180 degrees to move from the first configuration to the second configuration.

4. The hand-operated tool according to claim 1, wherein the tool head has a plurality of spaced apart tines such the tool head is a fork in the first configuration and a rake in the second configuration.

5. The hand-operated tool according to claim 1, wherein the lock has a release button which releases the lock when depressed to permit the tool head to pivot between the first and second configurations.

6. The hand-operated tool according to claim 1, wherein the handle includes an arm, a rear grip located at an end of the arm, and a fore grip located between the tool head and the rear grip.

7. The hand-operated tool according to claim 6, wherein the rear grip includes loop handle and the fore grip includes a knob.

8. The hand-operated tool according to claim 6, wherein the fore grip is longitudinally movable along a longitudinal axis of the handle to adjust the longitudinal distance between the fore grip and the tool head and the fore grip is secured against rotation about the longitudinal axis of the handle.

9. The hand-operated tool according to claim 7, wherein the rear grip and the fore grip are each secured against rotation about a longitudinal axis of the handle.

10. A hand-operated tool comprising, in combination:
a tool head;
a handle extending from the tool head;
wherein the handle includes a handle member having a loop handle forming a rear grip;
wherein the handle member has a forward grip spaced apart from the rear grip and located forward of the rear grip; and
wherein the forward grip includes a knob.

11. The hand-operated tool according to claim 10, wherein the fore grip is longitudinally movable along a longitudinal axis of the handle to adjust the longitudinal distance between the fore grip and the tool head.

12. The hand-operated tool according to claim 11, wherein the fore grip is secured against rotation about the longitudinal axis of the handle.

13. The hand-operated tool according to claim 12, wherein the handle includes an arm having a noncircular cross-section and the fore grip has a passage closely receiving the arm to secure the fore grip against rotation about the longitudinal axis of the handle.

14. The hand-operated tool according to claim 13, wherein the arm has an oval-shaped cross-section.

15. The hand-operated tool according to claim 10, wherein the rear grip and the fore grip are each secured against rotation about a longitudinal axis of the handle.

16. The hand-operated tool according to claim 15, wherein the tool head is pivotably secured to the handle to pivot between first and second configurations and a lock releasably locks the tool head relative to the handle in each of the first and second configurations.

17. A hand-operated tool comprising, in combination:
a tool head having a plurality of tines;
a handle extending from the tool head; and
a cutting member secured to the head and having a point at a free end.

18. The hand-operated tool according to claim 17, wherein an edge of the cutting member forms a cutting edge.

19. The hand-operated tool according to claim 17, wherein the tool head is pivotably secured to the handle to pivot about a longitudinal axis between a fork configuration and a rake configuration and a lock releasably locks the tool head relative to the handle in each of the fork and rake configurations.

20. The hand-operated tool according to claim 19, wherein the handle includes an arm, a rear grip including a loop handle located at an end of the arm, and a fore grip including a knob located between the tool head and the rear grip, and wherein the rear grip and the fore grip are each secured against rotation about a longitudinal axis of the handle.
